(19) United States
(12) Patent Application Publication
(10) Pub. No.: US 2021/0264462 A1
(43) Pub. Date: Aug. 26, 2021

(54) LEARNING DATA GENERATION DEVICE, PLAY SCHEDULE LEARNING SYSTEM, AND LEARNING DATA GENERATION METHOD

(71) Applicant: SHARP KABUSHIKI KAISHA, Osaka (JP)

(72) Inventor: KOHJI KUMETANI, Osaka (JP)

(21) Appl. No.: 17/153,550

(22) Filed: Jan. 20, 2021

(30) Foreign Application Priority Data
Feb. 21, 2020 (JP) 2020-028245

(51) Int. Cl. G06Q 30/02; G06N 20/00; G06K 9/00

(52) U.S. Cl. CPC G06Q 30/0242; G06K 9/00335; G06N 20/00

(57) ABSTRACT

A learning data generation device includes an image acquirer that acquires the captured image of a person in front of a displayer that displays content, a person determiner that determines the behavior of the person on the basis of the captured image acquired by the image acquirer, an evaluation value setter that sets an evaluation value for the content on the basis of the behavior of the person determined by the person determiner, and a learning data generator that generates learning data in which the content and the evaluation value are associated with each other.

### INCORPORATION BY REFERENCE

This application is based upon and claims the benefit of priority from the corresponding Japanese Patent Application No. 2020-28245 filed on Feb. 21, 2020, the entire contents of which are incorporated herein by reference.

The present disclosure relates to a learning data generation device that generates learning data for creating a play schedule for playing content, a play schedule learning system, and a learning data generation method.

### BACKGROUND

Conventionally, a content display system called digital signage is known, which is installed in public facilities and displays content such as an advertisement. In general, the content display system repeatedly plays the content on the basis of a preset play schedule.

Here, the play schedule of the content is created by the administrator of the content. For example, with regard to a plurality of contents related to an advertisement, the administrator predicts the time zone when the effect of each advertisement can be expected most, and creates a play schedule. In addition, the administrator may actually play a plurality of contents on the basis of the created play schedule, verify the effect of the advertisement, and rearrange the play schedule. As described above, in the conventional system, the workload of the administrator who creates the play schedule of the content is heavy, and it is difficult to create an optimal play schedule.

### SUMMARY

An object of the present disclosure is to provide a learning data generation device, a play schedule learning system, and a learning data generation method, that can easily create an optimal play schedule for playing content.

A learning data generation device according to one aspect of the present disclosure is a learning data generation device that generates learning data for creating a play schedule of content, and includes an image acquirer that acquires a captured image of a person in front of a displayer that displays content, a person determiner that determines the behavior of the person on a basis of the captured image acquired by the image acquirer, an evaluation value setter that sets an evaluation value for the content on a basis of the behavior of the person determined by the person determiner, and a learning data generator that generates the learning data in which the content and the evaluation value are associated with each other.

A play schedule learning system according to an other aspect of the present disclosure includes the learning data generation device and a learning device that performs machine learning with a use of the learning data generated by the learning data generation device to thereby generate a learned model.

A learning data generation method according to an other aspect of the present disclosure is a learning data generation method that generates learning data for creating a play schedule of content, and executes, by one or more processors, acquiring an captured image of a person in front of a displayer that displays the content, determining a behavior of the person on a basis of the captured image acquired by the acquiring, setting an evaluation value for the content on a basis of the behavior of the person determined by the determining, and generating the learning data in which the content and the evaluation value are associated with each other.

According to the present disclosure, it is possible to generate learning data with which an optimal play schedule for playing content can be easily created.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating an overview configuration of a content management system according to an embodiment of the present disclosure.

FIG. 2 is a block diagram illustrating a configuration of the content management system according to the embodiment of the present disclosure.

FIG. 3 is a table illustrating an example of content registered in a content management server according to the embodiment of the present disclosure.

FIG. 4 is a table illustrating an example of learning data generated in a content display system according to the embodiment of the present disclosure.

FIG. 5 is a table illustrating an example of a play schedule created in the content management server according to the embodiment of the present disclosure.

FIG. 6 is a flowchart for explaining an example of the procedure for a learning data generation process executed in the content display system according to the embodiment of the present disclosure.

FIG. 7 is a table illustrating an example of evaluation information used in the content display system according to the embodiment of the present disclosure.

FIG. 8 is a graph illustrating an example of a cumulative effect point calculated in the content display system according to an embodiment of the present disclosure.

FIG. 9 is a flowchart for explaining an example of the procedure for a play schedule creation process executed in the content management server according to the embodiment of the present disclosure.

### DETAILED DESCRIPTION

Hereinafter, an embodiment of the present disclosure will be described with reference to the accompanying drawings. The following embodiment represents an example of implementing the present disclosure, and does not limit the technical scope of the present disclosure.

A content display system 2 according to the present embodiment is applied to a system that displays (plays) content including video and audio such as an advertisement in various places such as stores, stations, streets, and offices. For example, the content display system 2 is suitable for a digital signage system.

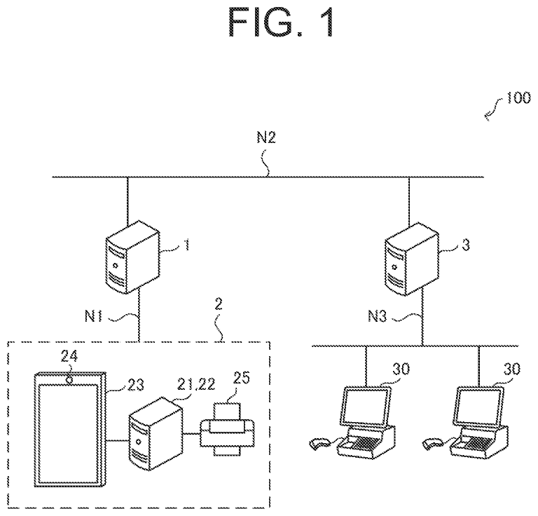

FIG. 1 is a diagram illustrating an overview configuration of a content management system 100 according to an embodiment of the present disclosure. The content management system 100 includes a content management server 1, a content display system 2, a POS management server 3, and a POS terminal 30. The content management server 1 and the content display system 2 are communicably connected to each other via a network N1. In addition, the content management server 1 and the POS management server 3 are communicably connected to each other via a network N2. Moreover, the POS management server 3 and the POS terminal 30 are communicably connected to each other via a network N3. The networks N1 and N2 are communication networks such as the Internet, a LAN, a WAN, or a public telephone line. The network N3 is a communication network such as wired LAN or wireless LAN, or a communication line between devices, such as HDMI (registered trademark), RS232C, and I2C.

In addition, the content management system 100 may include a plurality of content display systems 2. Moreover, the content management system 100 may include a plurality of POS terminals 30. In a case where the content management system 100 includes a plurality of content display systems 2, each content display system 2 is disposed in a different location corresponding to the content management server 1. In addition, the content management server 1 monitors and controls, for example, a plurality of content display systems 2, and distributes signage data including content and a play schedule to each content display system 2. The content management server 1 may be one or multiple. Moreover, the content management server 1 and the POS management server 3 may be integrally configured.

The content management server 1 distributes and manages content. Hereinafter, a specific configuration of the content management system 100 will be described. In the following embodiment, as an example of the content management system 100, a configuration will be described, in which the content management server 1 distributes the signage data including the content and the play schedule to the content display system 2, and the content display system 2 plays the content on the basis of the play schedule.

### Content Management Server 1

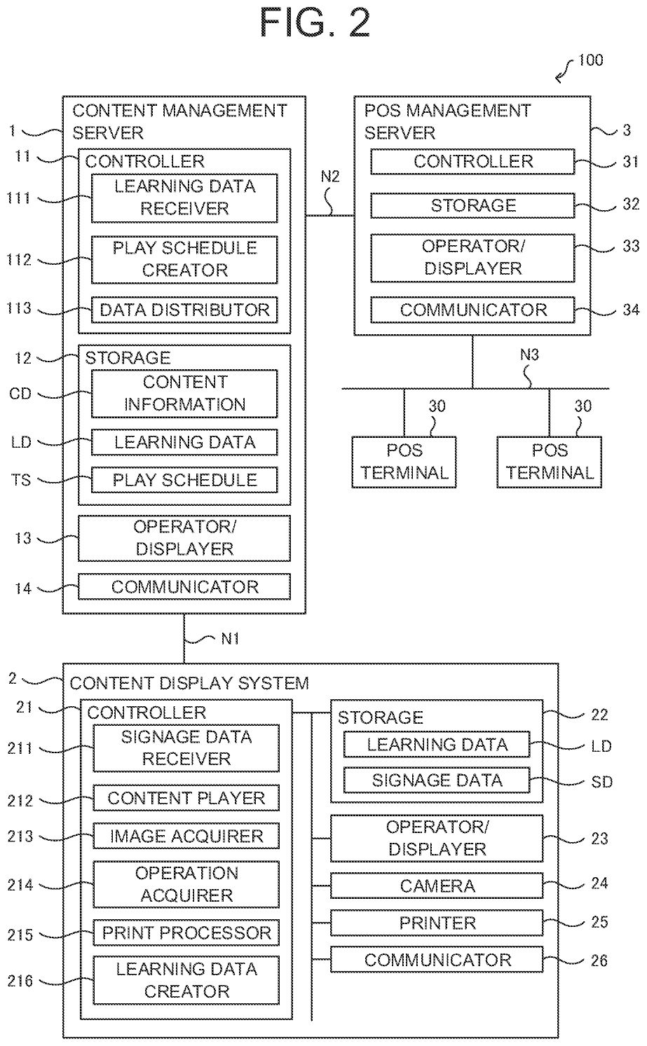

As illustrated in FIG. 2, the content management server 1 includes a controller 11, a storage 12, an operator/displayer 13, a communicator 14, and the like. The content management server 1 may be an information processing apparatus such as a personal computer.

The communicator 14 connects the content management server 1 to the network N1 by wire or wirelessly, and executes data communication with the content display system 2 via the network N1 in accordance with a predetermined communication protocol. In addition, the communicator 14 connects the content management server 1 to the network N2 by wire or wirelessly, and executes data communication with the POS management server 3 via the network N2 in accordance with a predetermined communication protocol.

The operator/displayer 13 is a user interface including a displayer such as a liquid crystal display or an organic EL display that displays various information and an operator such as a mouse, a keyboard, or a touch panel that receives an operation. The operator/displayer 13 accepts, for example, the operation of the administrator of the content management server 1. The administrator has the authority to manage the content to be distributed.

The storage 12 is a non-volatile storage such as a flash memory for storing various information. The storage 12 stores a control program for causing the controller 11 to execute various processing, such as a play schedule creation program. For example, the play schedule creation program is non-temporarily recorded on a computer-readable recording medium such as a USB (registered trademark) memory, a CD, or a DVD, and is stored in the storage 12 of the content management server 1 from these recording media.

In addition, the storage 12 stores content data corresponding to the content to be displayed on the content display system 2 and content information CD related to the content. Moreover, the storage 12 stores learning data LD for generating a play schedule indicating the display date/time (display start date/time, display end date/time, required time for playing), display order, and the like of the content. Furthermore, the storage 12 stores the identification information of the content display system 2 of the output destination of the content, a play schedule TS indicating the play schedule, and the like in association with the content.

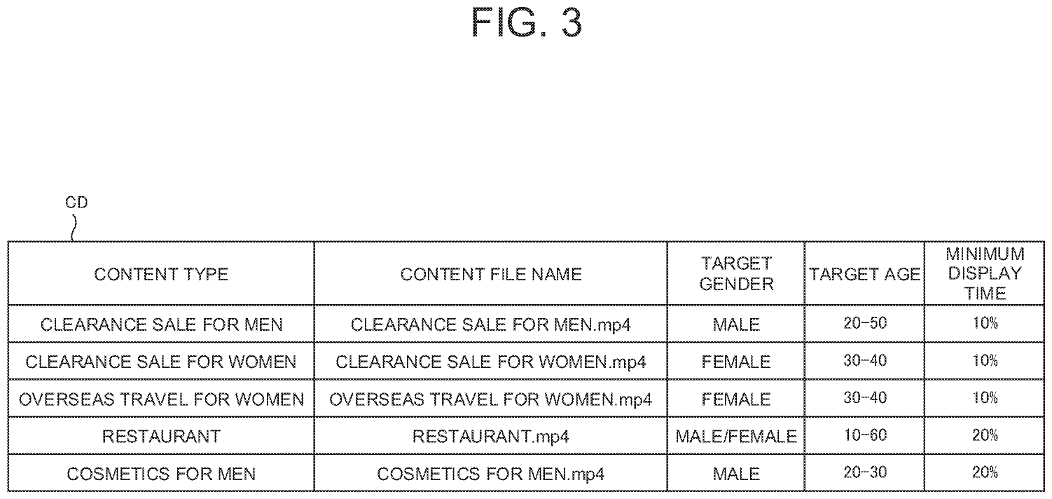

FIG. 3 illustrates an example of the content information CD. Information such as a “content type”, a “content file name”, a “target gender”, a “target age”, and a “minimum display time” is registered in the content information CD for each content. The “content type” is information indicating the type of content. The “content file name” is the file name of the content data. The “target gender” and “target age” are the gender and age of a viewer group (purchasing group) that is the target of marketing of advertisements corresponding to the content. The “minimum display time” is the lower limit of the play time of the content. For example, the ratio of the operation time of the content display system 2 to the total display time of the day is registered in the “minimum display time”. The “target gender”, “target age”, and “minimum display time” are set by the administrator. The administrator can update the content information CD as appropriate.

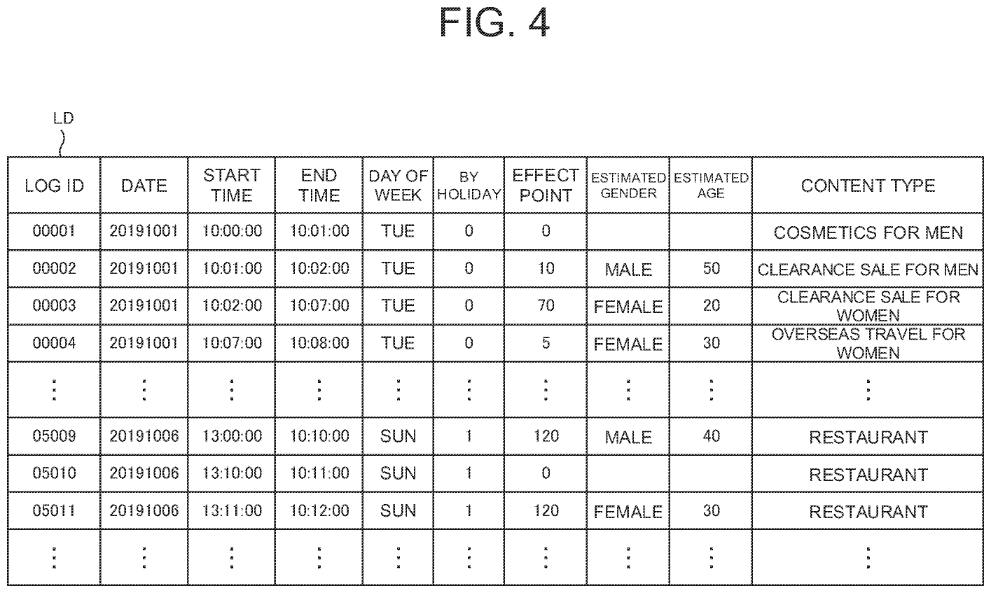

FIG. 4 illustrates an example of the learning data LD. The learning data LD is generated on the basis of the information acquired by playing the content in the content display system 2. The specific method for generating the learning data LD will be described later. When receiving the learning data LD from the content display system 2, the content management server 1 stores the learning data in the storage 12.

In the learning data LD, information such as “log ID”, “date”, “start time”, “end time”, “day of week”, “by holiday”, “effect point”, “estimated gender”, “estimated age”, and “content type” is registered for each play time. The “date” is the play date of the content, the “start time” is the time when the play of the content starts, and the “end time” is the time when the play of the content ends. The “effect point” is information that quantifies the effect obtained by playing the content (an example of the evaluation value of the present invention). The method for calculating the effect point will be described later. The “estimated gender” is the estimated gender of a viewer who watched the content, and the “estimated age” is the estimated age of the viewer who watched the content. The estimated gender and estimated age are estimated on the basis of the captured image of the camera 24 provided in the content display system 2. The type of played content is registered in the “content type”.

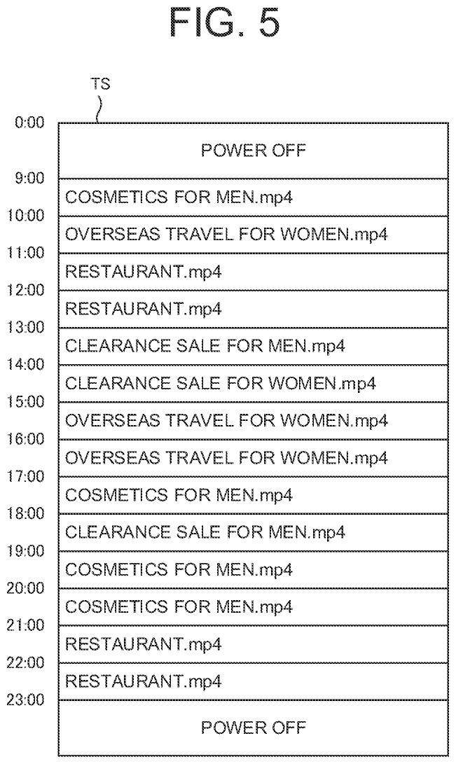

FIG. 5 illustrates an example of the play schedule TS. The play schedule TS is created by the controller 11 of the content management server 1 on the basis of the learning data LD. The play schedule TS includes a time table and content information (content file name) assigned to the time table.

The controller 11 includes control devices such as a CPU, a ROM, and a RAM. The CPU is a processor that executes various arithmetic processing. The ROM is a non-volatile storage in which a control program such as a BIOS and an OS for causing the CPU to execute various processing is stored in advance. The RAM is a volatile or non-volatile storage that stores various information, and is used as a temporary storage memory (working area) for various processing executed by the CPU. In addition, the controller 11 controls the content management server 1 by causing the CPU to execute various control programs stored in advance in the ROM or the storage 12.

Specifically, the controller 11 includes various processors such as a learning data receiver 111, a play schedule creator 112, and a data distributor 113.

The controller 11 functions as the various processors by executing various processing according to the play schedule creation program. Furthermore, some or all of the processors included in the controller 11 may be configured by an electronic circuit. The play schedule creation program may be a program for causing a plurality of processors to function as the various processors.

The learning data receiver 111 receives the learning data LD generated in the content display system 2 from the content display system 2. When receiving the learning data LD, the learning data receiver 111 stores the learning data LD in the storage 12 (see FIG. 4).

The play schedule creator 112 creates the play schedules TS (see FIG. 5) of a plurality of contents included in the content information CD, on the basis of the learning data LD. The specific method for creating the play schedule TS will be described later.

The data distributor 113 distributes the signage data SD including a plurality of contents (content data) included in the content information CD and the play schedule TS of each content to the content display system 2. The data distributor 113 can distribute the play schedule TS created manually by the administrator and the play schedule TS created by the play schedule creator 112 to the content display system 2.

### Content Display System 2

As illustrated in FIG. 2, the content display system 2 includes a controller 21, a storage 22, an operator/displayer 23, a camera 24, a printer 25, a communicator 26, and the like. The content display system 2 may be an information processing apparatus such as a personal computer. In addition, the content display system 2 may include, for example, an STB (Set Top Box) and a display.

The communicator 26 connects the content display system 2 to the network N1 by wire or wirelessly, and executes data communication with the content management server 1 via the network N1 in accordance with a predetermined communication protocol.

The printer 25 can execute printing processing based on image data by an electrophotographic method or an inkjet method, and forms an image on a sheet on the basis of the image data.

The operator/displayer 23 is a user interface including a displayer such as a liquid crystal display or an organic EL display that displays various information such as content and an operator such as a touch panel that accepts the operation of a user (viewer).

The camera 24 is, for example, a digital camera that is installed so as to be able to capture a predetermined range in front of the operator/displayer 23, captures an image of a person (viewer) who is a subject, and outputs the image as digital image data.

The storage 22 is a non-volatile storage such as a flash memory for storing various information. The storage 22 stores a control program for causing the controller 21 to execute various processing, such as a learning data generation program. For example, the learning data generation program is non-temporarily recorded on a computer-readable recording medium such as a USB (registered trademark) memory, a CD, or a DVD, and is stored in the storage 22 of the content display system 2 from these recording media.

In addition, the storage 22 stores the learning data LD generated by the controller 21, the signage data SD distributed from the content management server 1, and the like.

The controller 21 includes control devices such as a CPU, a ROM, and a RAM. The CPU is a processor that executes various arithmetic processing. The ROM is a non-volatile storage in which a control program such as a BIOS and an OS for causing the CPU to execute various processing is stored in advance. The RAM is a volatile or non-volatile storage that stores various information, and is used as a temporary storage memory (working area) for various processing executed by the CPU. In addition, the controller 21 controls the content display system 2 by causing the CPU to execute various control programs stored in advance in the ROM or the storage 22.

Specifically, the controller 21 includes various processors such as a signage data receiver 211, a content player 212, an image acquirer 213, an operation acquirer 214, a print processor 215, and a learning data generator 216.

The controller 21 functions as the various processors by executing various processing according to the learning data generation program. In addition, some or all of the processors included in the controller 21 may be configured by an electronic circuit. The learning data generation program may be a program for causing a plurality of processors to function as the various processors.

The signage data receiver 211 receives the signage data SD distributed from the content management server 1. The signage data SD includes a plurality of contents (content data) included in the content information CD, and the play schedule TS of each content. The signage data receiver 211 stores the received signage data SD in the storage 22.

The content player 212 causes the operator/displayer 23 to display the content on the basis of the play schedule TS. The play schedule TS includes the play schedule TS created manually by the administrator and the play schedule TS created by the play schedule creator 112 of the content management server 1. Thus, the content player 212 causes to display the content on the basis of either of the play schedules TS.

The image acquirer 213 acquires a captured image of a person (viewer) in front of the operator/displayer 23, which is captured by the camera 24.

The operation acquirer 214 acquires operation information related to the viewer's operation on the operator/displayer 23. For example, when the viewer performs a touch operation on the operator/displayer 23 displaying the content, the operation information is acquired.

The print processor 215 outputs a print instruction to the printer 25 to execute print processing. For example, when the operation acquirer 214 acquires an operation for requesting specific information from the viewer, the print processor 215 causes the printer 25 to execute print processing for printing the specific information. The specific information is benefit information that can be used in facilities corresponding to content, such as discount coupons, usage tickets, and service tickets that can be used in various facilities such as retail stores, restaurants, entertainment facilities, and accommodation facilities.

The learning data generator 216 generates the learning data LD for creating the play schedule TS of content. For example, the learning data generator 216 generates the learning data LD on the basis of the captured image acquired by the image acquirer 213. The specific method for generating the learning data LD will be described later. The learning data generator 216 stores the generated learning data LD in the storage 22. In addition, the learning data generator 216 transmits the generated learning data LD to the content management server 1. The learning data generator 216 attaches the identification information (device information, position information, etc.) of the content display system 2 to the learning data LD, and transmits the learning data LD to the content management server 1.

### POS Management Server 3

As illustrated in FIG. 2, the POS management server 3 includes a controller 31, a storage 32, an operator/displayer 33, a communicator 34, and the like.

The communicator 34 connects the POS management server 3 to the network N2 by wire or wirelessly, and executes data communication with the content management server 1 via the network N2 in accordance with a predetermined communication protocol. In addition, the communicator 34 connects the POS management server 3 to the network N3 by wire or wirelessly, and executes data communication with the POS terminal 30 via the network N3 in accordance with a predetermined communication protocol.

The operator/displayer 33 is a user interface including a displayer such as a liquid crystal display or an organic EL display that displays various information and an operator such as a touch panel that accepts the operation of a user (store manager).

The storage 32 is a non-volatile storage such as a flash memory for storing various information. The storage 32 stores a control program for causing the controller 31 to execute various processing. For example, the control program is non-temporarily recorded on a computer-readable recording medium such as a USB (registered trademark) memory, a CD, or a DVD, and is stored in the storage 32 of the POS management server 3 from these recording media.

In addition, the storage 32 stores POS data such as purchase information acquired from each POS terminal 30.

The controller 31 includes control devices such as a CPU, a ROM, and a RAM. The CPU is a processor that executes various arithmetic processing. The ROM is a non-volatile storage in which a control program such as a BIOS and an OS for causing the CPU to execute various processing is stored in advance. The RAM is a volatile or non-volatile storage that stores various information, and is used as a temporary storage memory (working area) for various processing executed by the CPU. In addition, the controller 31 controls the POS management server 3 by causing the CPU to execute various control programs stored in advance in the ROM or the storage 32.

### Method for Generating Learning Data LD

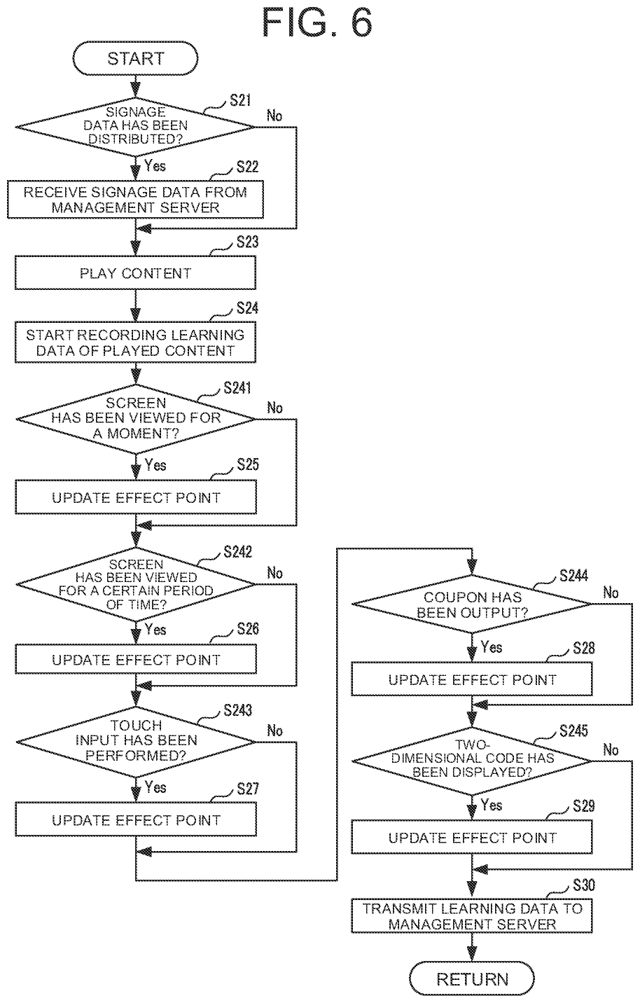

Hereinafter, an example of the procedure for a learning data generation process executed by the controller 21 of the content display system 2 will be described with reference to FIG. 6. A part of the learning data generation process may be executed by the controller 11 of the content management server 1.

The present disclosure can be considered an invention of a method for generating learning data, which executes one or more of the steps included in the learning data generation process. In addition, one or more of the steps included in the learning data generation process described here may be appropriately omitted. Moreover, each step in the learning data generation process may be executed in a different order as long as the same effect is obtained. Furthermore, a case where each step in the learning data generation process is executed by the controller 21 will be described here as an example. However, in another embodiment, each step in the learning data generation process may be executed in a distributed fashion by a plurality of processors.

First, in step S21, the controller 21 determines whether the signage data SD has been distributed from the content management server 1. If the signage data SD has been distributed from the content management server 1 (S21: Yes), the processing proceeds to step S22, and if the signage data SD has not been distributed from the content management server 1 (S21: No), the processing proceeds to step S23.

In step S22, the controller 21 receives the signage data SD from the content management server 1. The controller 21 stores the received signage data SD in the storage 22. The controller 21 stores the signage data SD in the storage 22 every time the signage data SD is received from the content management server 1. Therefore, the latest signage data SD is stored in the storage 22.

In step S23, the controller 21 plays the content on the basis of the signage data SD stored in the storage 22. For example, the controller 21 plays a plurality of contents in order, on the basis of the play schedule TS included in the signage data SD.

In step S24, the controller 21 starts recording the learning data LD corresponding to the played content. Specifically, the controller 21 acquires a captured image of a person (viewer) captured by the camera 24, determines the behavior of the person on the basis of the captured image, and records the information corresponding to the processing of the following steps S241 to S245 as the learning data LD.

In step S241, the controller 21 analyzes the captured image to determine whether the viewer has viewed for a moment the display screen displaying the content. If it is determined that the viewer has viewed the display screen for a moment (S241: Yes), the processing proceeds to step S25, and if it is not determined that the viewer has viewed the display screen for a moment (S241: No), the processing proceeds to S242.

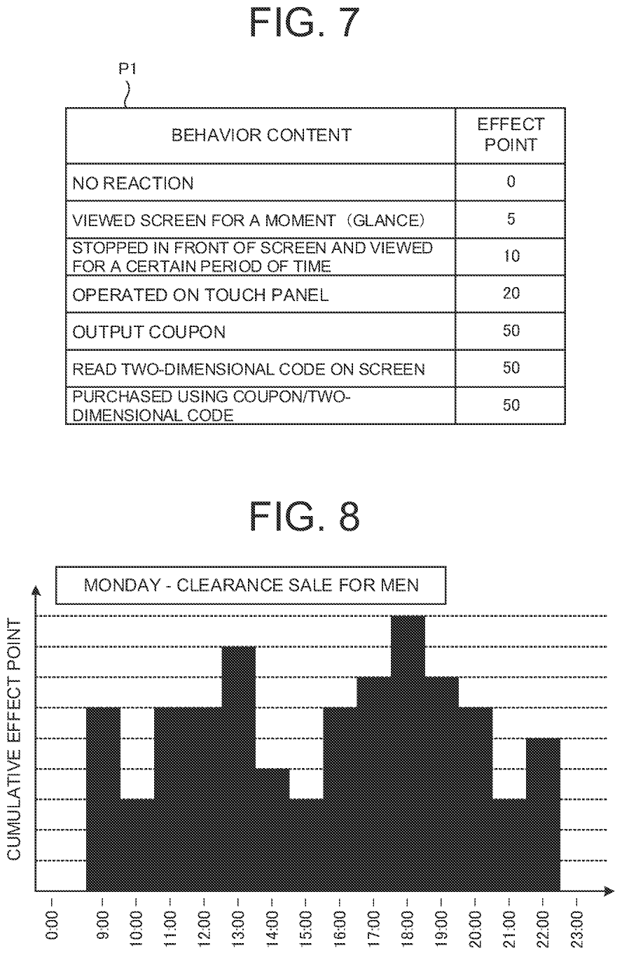

In step S25, the controller 21 updates the effect point. Specifically, the controller 21 updates the effect point with reference to evaluation information P1. FIG. 7 illustrates an example of the evaluation information P1. The evaluation information P1 is stored in the storage 22 in advance.

In the evaluation information P1, the viewer's behavior content and the effect point corresponding to the behavior content are associated with each other and registered. As for the effect point, the more the viewer's behavior is determined to be of high interest in the content, the higher the point is set. That is, the effect point (evaluation value) corresponds to the degree of interest of the viewer in the content. For example, if the content is displayed on the display screen but the viewer passes by without looking at the display screen, it can be determined that the viewer is not interested in the content. Thus, “0” is set as the effect point corresponding to the behavior of “no reaction”. In addition, for example, when the viewer performs a touch operation on the display screen (such as an operation for requesting a coupon) while the content is displayed on the display screen, it can be determined that the viewer is interested in the content. Thus, a high value is set to the effect point for such behavior.

For example, in a case where the controller 21 plays the content of “cosmetics for men” during the time zone from 10:00-10:01 on Jan. 1, 2019, when the viewer (passerby) has passed by without looking at the display screen, the controller 21 determines that the behavior content for the content is “no reaction”. In this case, the controller 21 registers the log information related to the content and the effect point “0” (see FIG. 7) in the learning data LD (see FIG. 4). On the other hand, when the viewer has viewed the display screen for a moment, the controller 21 determines that the behavior content for the content is “viewed screen for a moment”. In this case, the controller 21 registers the log information related to the content and the effect point “5” in the learning data LD.

In step S242, the controller 21 analyzes the captured image to determine whether the viewer has viewed for a certain period of time the display screen displaying the content. If it is determined that the viewer has viewed the display screen for a certain period of time (S242: Yes), the processing proceeds to step S26, and if it is not determined that the viewer has viewed the display screen for a certain period of time (S242: No), the processing proceeds to S243.

In step S26, the controller 21 updates the effect point. For example, when the viewer has viewed the display screen for a certain period of time, the controller 21 determines that the behavior content for the content is “stopped in front of screen and viewed for a certain period of time”. In this case, the controller 21 registers the log information related to the content and the effect point “10” (see FIG. 7) in the learning data LD.

In step S243, the controller 21 analyzes the captured image to determine whether the viewer has performed a touch operation on the display screen displaying the content. If it is determined that the viewer has performed a touch operation on the display screen (S243: Yes), the processing proceeds to step S27, and if it is not determined that the viewer has performed a touch operation on the display screen (S243: No), the processing proceeds to S244.

In step S27, the controller 21 updates the effect point. For example, when the viewer has performed a touch operation on the display screen, the controller 21 determines that the behavior content for the content is “operated on touch panel”. In this case, the controller 21 registers the log information related to the content and the effect point “20” (see FIG. 7) in the learning data LD. In addition, for example, when the viewer has continuously performed a touch operation after viewing the display screen for a certain period of time, the controller 21 determines that the behavior content for the content is “stopped in front of screen and viewed for a certain period of time” and “operated on touch panel”. In this case, the controller 21 updates the effect point to “30” by adding the effect point “20” corresponding to the latter behavior to the effect point “10” corresponding to the former behavior. In this way, the controller 21 sets the effect point when the person looks at the operator/displayer 23 and performs a touch operation to a value higher than the effect point when the person looks at the operator/displayer 23 and does not perform the touch operation.

In step S244, the controller 21 analyzes the captured image to determine whether the viewer has performed an operation for requesting a coupon on the display screen while displaying the content. If it is determined that the viewer has performed an operation for requesting a coupon (S244: Yes), the processing proceeds to step S28, and if it is not determined that the viewer has performed an operation for requesting a coupon (S244: No), the processing proceeds to S245.

The coupon is, for example, discount information of a product included in an advertisement corresponding to the content. The viewer can purchase the product at a discounted price by acquiring the coupon. For example, when the viewer wishes to purchase a product included in the displayed content, the viewer performs an operation for requesting a coupon on the display screen. When acquiring the operation information, the controller 21 outputs the discount coupon of the product from the printer 25. If the viewer acquires the coupon, the viewer visits a store that sells the product and purchases the product with the use of the coupon. The POS terminal 30 of the store transmits the purchase information to the POS management server 3. In addition, the POS management server 3 transmits the purchase information to the content management server 1. The purchase information includes information (usage history information) indicating that the coupon has been used.

In step S28, the controller 21 updates the effect point. For example, when the viewer performs an operation for requesting a coupon on the display screen, the controller 21 determines that the behavior content for the content is “output coupon”. In this case, the controller 21 registers the log information related to the content and the effect point “50” (see FIG. 7) in the learning data LD. In addition, for example, when the viewer has continuously performed a touch operation and output the coupon after viewing the display screen for a certain period of time, the controller 21 updates the effect point to “80” by adding an effect point according to each behavior content. In this way, the controller 21 sets the effect point when the person looks at the operator/displayer 23 and performs an operation to output a coupon to a value higher than the effect point when the person looks at the operator/displayer 23 and does not perform the operation to output the coupon.

Here, when the viewer purchases a product corresponding to the content with the use of the coupon, it can be determined that the viewer's interest in the content is even higher. Therefore, when receiving the information (usage history information) indicating that the coupon has been used from the content management server 1, the controller 21 updates the effect point. For example, the controller 21 updates the effect point to “130” by adding the effect point “50” corresponding to the behavior content “purchased using coupon” to the effect point “80”. In this way, the controller 21 updates the effect point for the content when the coupon corresponding to the content is used in a facility.

In step S245, the controller 21 analyzes the captured image to determine whether the viewer has performed an operation to display a two-dimensional code on the display screen while displaying the content. If it is determined that the viewer has performed an operation to display a two-dimensional code (S245: Yes), the processing proceeds to step S29, and if it is not determined that the viewer has performed an operation to display a two-dimensional code (S245: No), the processing proceeds to S30.

The two-dimensional code corresponds to the electronic data of the coupon. For example, the viewer can acquire the coupon information by reading the two-dimensional code displayed on the display screen with the viewer's mobile terminal. The viewer can use the coupon by displaying the coupon information on the mobile terminal and having the POS terminal 30 read the coupon information. The POS terminal 30 may include a reader (for example, a bar code reader) that reads the coupon information (see FIG. 1).

In step S29, the controller 21 updates the effect point. For example, when the viewer performs an operation to display a two-dimensional code on the display screen, the controller 21 determines that the behavior content for the content is “read two-dimensional code on screen”. In this case, the controller 21 registers the log information related to the content and the effect point “50” (see FIG. 7) in the learning data LD. In addition, for example, when the viewer has continuously performed a touch operation and read a two-dimensional code after viewing the display screen for a certain period of time, the controller 21 updates the effect point to “80” by adding an effect point according to each behavior content.

In this way, the controller 21 determines the viewer's behavior content for the content while displaying the content, and sets the effect point corresponding to the behavior content. Specifically, the controller 21 determines whether the person has viewed the operator/displayer 23, whether the person has performed a touch operation on the operator/displayer 23, and whether the person has operated the operator/displayer 23 and output specific information, on the basis of the captured image, and set the effect point according to the determination result. Then, the controller 21 generates learning data LD in which the content and the effect point are associated with each other. FIG. 4 is a diagram illustrating an example of the learning data LD generated in this way.

In step S30, the controller 21 transmits the generated learning data LD to the content management server 1. After that, the processing returns to step S21 and the above processing is repeated. That is, the controller 21 sets the effect points for the plurality of contents repeatedly displayed on the operator/displayer 23, and updates the learning data LD every time the plurality of contents are displayed.

In the above process, the controller 21 calculates the effect point of each content while playing a plurality of contents in accordance with the play schedule TS. However, as an other method, the controller 21 may calculate the effect point per unit time of the content while continuously playing each content for a predetermined time. For example, when receiving the signage data SD of the “clearance sale for men” from the content management server 1, the controller 21 continuously plays the content of “clearance sale for men” during the operation time “Monday 9:00-23:00” of the content display system 2. Then, the controller 21 determines the viewer's behavior content for the content and calculates the effect point. Specifically, the controller 21 calculates a cumulative effect point every hour. For example, the cumulative effect point of the time zone of “9:00-10:00” is calculated by adding the effect point of each behavior performed by the viewer for the content in the time zone. FIG. 8 is a graph illustrating the cumulative effect point corresponding to the content. According to the graph illustrated in FIG. 8, it can be seen that the content has a high effect point in the time zone of “13:00-14:00” and “18:00-19:00”. The controller 21 calculates the cumulative effect point for each content. Then, the controller 21 generates the learning data LD in which the content and the cumulative effect point are associated with each other, and transmits the generated learning data LD to the content management server 1.

Here, the controller 21 that executes the learning data generation process is an example of the learning data generation device of the present disclosure. That is, the controller 21 functions as the learning data generation device that generates learning data for creating a play schedule of content. In addition, the controller 21 functions as an image acquirer (image acquirer 213) that acquires an captured image of a person in front of a displayer (operator/displayer 23) that displays the content, a person determiner that determines a behavior of the person on the basis of the captured image, an evaluation value setter that calculates an effect point (evaluation value) for the content on the basis of the behavior of the person, and a learning data generator (learning data generator 216) that generates learning data LD in which the content and the effect point are associated with each other.

### Method for Creating Play Schedule TS

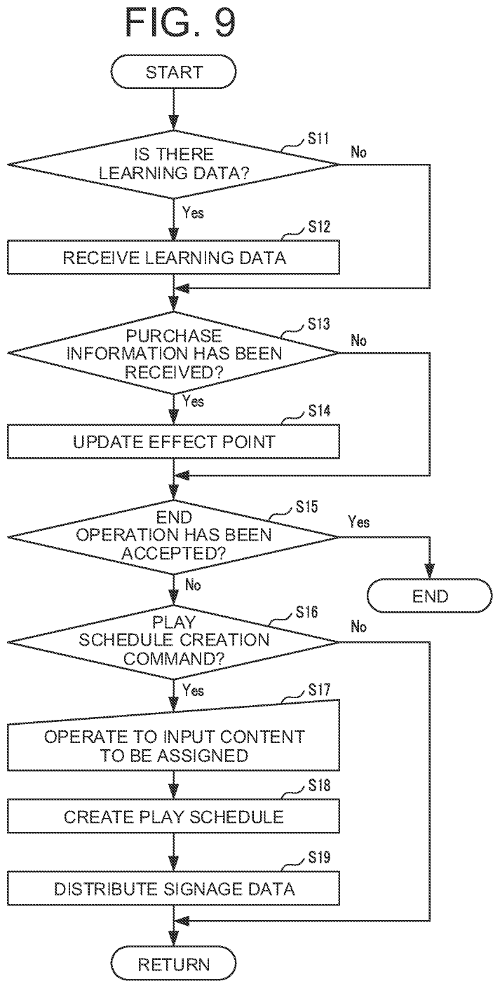

Hereinafter, an example of the procedure for a play schedule creation process executed by the controller 11 of the content management server 1 will be described with reference to FIG. 9.

The present disclosure can be considered an invention of a method for creating a play schedule, which executes one or more of the steps included in the play schedule creation process. In addition, one or more of the steps included in the play schedule creation process described here may be appropriately omitted. Moreover, each step in the play schedule creation process may be executed in a different order as long as the same effect is obtained. Furthermore, a case where each step in the play schedule creation process is executed by the controller 11 will be described here as an example. However, in an other embodiment, each step in the play schedule creation process may be executed in a distributed fashion by a plurality of processors.

First, in step S11, the controller 11 determines whether the learning data LD has been transmitted from the content display system 2. If the learning data LD has been transmitted from the content display system 2 (S11: Yes), the processing proceeds to step S12, and if the learning data LD has not been transmitted from the content display system 2 (S11: No), the processing proceeds to step S13.

In step S12, the controller 11 receives the learning data LD from the content display system 2. The controller 11 stores the received learning data LD in the storage 12 (see FIG. 4). The controller 11 stores the learning data LD in the storage 12 every time the learning data LD is received from the content display system 2. Therefore, the latest learning data LD is stored in the storage 12.

In step S13, the controller 11 determines whether the purchase information has been received from the POS management server 3. If the controller 11 has received the purchase information (S13: Yes), the processing proceeds to step S14, and when the controller 11 has not received the purchase information (S13: No), the processing proceeds to step S15.

In step S14, the controller 11 updates the effect point. For example, when the viewer has performed a touch operation and output the coupon after viewing the display screen for a certain period of time, “80” is registered in the learning data LD as the effect point. After that, when the viewer purchases with the use of the coupon, the controller 11 receives the purchase information from the POS management server 3. In this case, the controller 11 updates the effect point “80” of the learning data LD to “130”. In addition, the controller 11 transmits the purchase information to the content display system 2. In the content display system 2, the controller 21 receives the purchase information and updates the effect point of the learning data LD of the storage 22 to “130”.

In step S15, the controller 11 determines whether the end operation has been accepted from the administrator. If the controller 11 has accepted the end operation (S15: Yes), the processing ends, and if the controller 11 has not accepted the end operation (S15: No), the processing proceeds to step S16.

In step S16, the controller 11 determines whether to execute a command for creating the play schedule TS. For example, when receiving the administrator's creation instruction, the controller 11 executes the command for creating the play schedule TS. If the above creation command is not executed (S16: No), the processing proceeds to step S11.

In step S17, the administrator performs an operation for inputting the content to be assigned to the play schedule TS, and the controller 11 accepts the operation. For example, the administrator inputs (registers) desired content in the content information CD as illustrated in FIG. 3.

In step S18, the controller 11 creates the play schedule TS. Specifically, the controller 11 assigns the content registered in the content information CD to the time table, on the basis of the learning data LD. For example, the controller 11 assigns each content to the time table in such a manner that the effect point of each content is high, on the basis of the learning data LD.

Here, the controller 11 generates the play schedule TS with the use of the learning data LD. Specifically, the controller 11 performs machine learning with the use of the learning data LD to thereby generate a learned model. For example, the controller 11 generates the learned model for estimating a play schedule corresponding to arbitrary content.

In addition, the machine learning includes algorithms such as supervised learning using supervised data, unsupervised learning using unsupervised data, and reinforcement learning. Moreover, in order to achieve these methods, a method called “deep learning” is used to learn the extraction of the feature amount per se. In the present embodiment, the controller 11 has a learning model based on the various algorithms described above. In the present embodiment, the content to which the effect point is associated corresponds to the supervised data, and the content to which the effect point is not associated corresponds to the unsupervised data. The controller 11 can estimate the play schedule by performing machine learning with the use of these supervised data and unsupervised data as input data.

Specifically, for example, when the information of arbitrary content (a content type, a target gender, a target age, a minimum display time, etc.) and the effect point associated with the content are input, the learned model estimates the optimal schedule (a display start time, a display end time, etc.) for playing the content.

The controller 11 creates the play schedule TS with the use of the generated learned model. That is, the controller 11 that generates the learned model is an example of the learning device of the present invention. That is, the controller 11 functions as the learning device that performs machine learning with the use of the learning data LD generated by the learning data generation device (controller 21) to thereby generate a learned model. The learned model may be stored in an external device. As a result, the device functions as the creation device (learning device) for the play schedule TS of content. In addition, the learned model may be downloadable to the device via a communication network such as the Internet.

For example, with regard to the content of “clearance sale for men”, if it is determined that the effect point is high in the time zones of “13:00-14:00” and “18:00-19:00” on the basis of the learning data LD illustrated in FIGS. 4 and 8, the controller 11 assigns the content to “13:00-14:00” and “18:00-19:00” of the time table (see FIG. 5). Every time the learning data LD is updated, the controller 11 estimates the optimal display time zone of the content and assigns same to the time table.

In addition, the controller 11 assigns the content to the timetable in consideration of the minimum display time (see FIG. 3). That is, the minimum display time is included in the learning data LD. As a result, each prepared content is assigned to the optimal display time zone while ensuring the minimum display time.

When the controller 11 assigns a plurality of contents to the time table and creates the play schedule TS (see FIG. 5) as described above, in step S19, the controller distributes the signage data SD including the plurality of contents and the play schedule TS to the content display system 2. After that, the processing returns to step S11 and the controller 11 repeats the above processing.

As described above, the content management system 100 according to the present embodiment acquires a captured image of a person in front of the operator/displayer 23 that displays the content, determines the behavior of the person on the basis of the captured image, and sets the evaluation value for the content on the basis of the behavior of the person. In addition, the content management system 100 generates learning data LD in which the content and the evaluation value are associated with each other. Then, the content management system 100 uses the learning data LD to create the optimal play schedule TS for the content. This makes it possible to reduce the workload of the administrator and easily create the optimal play schedule TS that can obtain the effect of advertising.

The present disclosure is not limited to the above-described embodiment. As an other embodiment, the controller 21 of the content display system 2 may determine the gender and age of the viewer on the basis of the captured image, and when the determined gender and age match the target gender and target age corresponding to the content, the controller 21 may update the effect point for the content. Specifically, when the estimated gender and age match the target gender and target age, the controller 21 updates the effect point to a value obtained by multiplying the effect point (see FIG. 4) set on the basis of the viewer's behavior by a coefficient of 1 or more. That is, the controller 21 may weight the effect point of each content in accordance with the gender and age of the viewer. This makes it possible to create an optimal play schedule TS that matches the target layer of the content.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. A learning data generation device that generates learning data for creating a play schedule of content, the learning data generation device comprising:
an image acquirer that acquires a captured image of a person in front of a displayer that displays the content;
a person determiner that determines a behavior of the person on a basis of the captured image acquired by the image acquirer;
an evaluation value setter that sets an evaluation value for the content on a basis of the behavior of the person determined by the person determiner; and
a learning data generator that generates the learning data in which the content and the evaluation value are associated with each other.

2. The learning data generation device according to claim 1, wherein the person determiner determines, on a basis of the captured image, whether the person has viewed the displayer, whether the person has performed a touch operation on an operator, and whether the person has operated the operator and output specific information.

3. The learning data generation device according to claim 2, wherein the evaluation value setter sets an evaluation value when the person has viewed the displayer and performed the touch operation to a value higher than an evaluation value when the person has viewed the displayer and has not performed the touch operation.

4. The learning data generation device according to claim 2, wherein the evaluation value setter sets an evaluation value when the person has viewed the displayer and has output the specific information to a value higher than an evaluation value when the person has viewed the displayer and has not performed an operation to output the specific information.

5. The learning data generation device according to claim 2, wherein the specific information is benefit information that can be used in a facility corresponding to the content.

6. The learning data generation device according to claim 5, wherein the evaluation value setter updates the evaluation value for the content when the specific information corresponding to the content is used in the facility.

7. The learning data generation device according to claim 1, wherein the person determiner further determines a gender and an age of the person on a basis of the captured image.

8. The learning data generation device according to claim 7, wherein the evaluation value setter updates the evaluation value for the content when the gender and age of the person determined by the person determiner match a target gender and a target age corresponding to the content.

9. The learning data generation device according to claim 1,
wherein the evaluation value setter sets the evaluation value for a plurality of contents repeatedly displayed on the displayer, and
wherein the learning data generator updates the learning data every time a plurality of contents are displayed.

10. A play schedule learning system comprising:
the learning data generation device according to claim 1; and
a learning device that performs machine learning with a use of the learning data generated by the learning data generation device to thereby generate a learned model.

11. The play schedule learning system according to claim 10, wherein the learning device generates the learned model that estimates a play schedule corresponding to arbitrary content.

12. A learning data generation method that generates learning data for creating a play schedule of content, the learning data generation method executing, by one or more processors:
acquiring a captured image of a person in front of a displayer that displays the content;
determining a behavior of the person on a basis of the captured image acquired by the acquiring;
setting an evaluation value for the content on a basis of the behavior of the person determined by the determining; and
generating the learning data in which the content and the evaluation value are associated with each other.
